(19) United States
(12) Patent Application Publication
(10) Pub. No.: US 2024/0128525 A1
(43) Pub. Date: Apr. 18, 2024

(54) MANAGEMENT METHOD OF ELECTROCHEMICAL DEVICE, ELECTRONIC DEVICE, CHARGING DEVICE AND STORAGE MEDIUM

(71) Applicant: Ningde Amperex Technology Limited, Ningde (CN)

(72) Inventors: Qi SUN, Ningde (CN); Huixin WANG, Ningde (CN); Ying WANG, Ningde (CN)

(73) Assignee: Ningde Amperex Technology Limited, Ningde (CN)

(21) Appl. No.: 18/394,406

(22) Filed: Dec. 22, 2023

Related U.S. Application Data
(63) Continuation of application No. PCT/CN2021/102455, filed on Jun. 25, 2021.

(51) Int. Cl. H01M 10/44; H01M 10/052; H02J 7/00

(52) U.S. Cl. CPC H01M 10/445; H01M 10/052; H01M 10/448; H02J 7/007182; H02J 7/007188

(57) ABSTRACT

A management method of an electrochemical device, includes: when the electrochemical device is in a preset state, measuring a predetermined parameter of the electrochemical device, and in response to the predetermined parameter meeting a preset condition, performing at least one discharge-charge operation on the electrochemical device. The discharge-charge operation includes: discharging the electrochemical device to a second voltage threshold, and charging the electrochemical device to a third voltage threshold. The second voltage threshold is less than a first voltage threshold, the first voltage threshold is a limited charge voltage of the electrochemical device, and a difference between the third voltage threshold and the first voltage threshold is not greater than 20%.

### CROSS-REFERENCE TO RELATED APPLICATION

The present application is a continuation application of PCT Application S.N. PCT/CN2021/102455, filed on Jun. 25, 2021, the content of which is incorporated herein by reference in its entirety.

### TECHNICAL FIELD

The present application relates to the field of electrochemical technology, and particular to a management method of an electrochemical device, an electronic device, a charging device and a storage medium.

### BACKGROUND

Lithium-ion batteries have many advantages, such as high specific energy density, long cycle life, high nominal voltage, low self-discharge rate, small volume and light weight, which are widely used in the field of consumer electronics.

In recent years, with the rapid development of consumer electronic products, such as tablet computers and mobile phones, the market demand for lithium-ion batteries is also increasing. However, consumer electronic products often face the condition of continuous high-voltage operation. Under this condition, lithium-ion batteries are prone to gas generation, which affects the service life of lithium-ion batteries.

### SUMMARY

The purpose of some embodiments of the present application is to provide a management method of an electrochemical device, an electronic device, a charging device and a storage medium, so as to delay gas generation of the electrochemical device.

A first aspect of some embodiments of the present application provides a management method of an electrochemical device. The method comprises: in a preset state of the electrochemical device, measuring a predetermined parameter of the electrochemical device, and in response to the predetermined parameter meeting a preset condition, performing at least one discharge-charge operation on the electrochemical device. The discharge-charge operation includes: discharging the electrochemical device to a second voltage threshold, and charging the electrochemical device to a third voltage threshold, wherein the second voltage threshold is less than a first voltage threshold, the first voltage threshold is a limited charge voltage of the electrochemical device, and a difference between the third voltage threshold and the first voltage threshold is not greater than 20%.

An embodiment of the present application includes the following technical effects: by measuring the predetermined parameter that can reflect a health degree of the electrochemical device, various embodiments of the present application performs the discharge-charge operation on the electrochemical device in response to the predetermined parameter meeting the preset conditions, so as to reduce the risk of reduction in performance, service life, etc. of the electrochemical device caused by gas generation and bulging due to long-term high voltage state. After the discharge-charge operation, the electrochemical device can still maintain sufficient power for easy use at any time.

In an implement solution, the step of in response to the predetermined parameter meeting the preset condition, performing at least one discharge-charge operation on the electrochemical device includes: in response to the predetermined parameter being not less than a preset threshold, performing at least one discharge-charge operation on the electrochemical device.

The predetermined parameter being not less than the preset threshold indicates that the health degree of the electrochemical device has decreased. By performing a discharge-charge operation on the electrochemical device upon the health degree of the electrochemical device has decreased, various embodiments of the present application reduces the risks of gas generation, bulging, etc., and prolongs the service life of the electrochemical device.

In an implement solution, the preset state includes at least one of the following: a working voltage of the electrochemical device is not less than the first voltage threshold, or the electrochemical device is electrically connected with a charging device.

In an implement solution, measuring a predetermined parameter of the electrochemical device includes measuring a thickness of the electrochemical device, and in response to the thickness being not less than a preset thickness, performing at least one discharge-charge operation on the electrochemical device.

The increase in the thickness of the electrochemical device indicates that gas generation may occur in the electrochemical device. By measuring a thickness change of the electrochemical device, this embodiment of the present application can timely detect a health problem of the electrochemical device, and inhibit the further gas generation of the electrochemical device by performing the discharge-charge operation on the electrochemical device, so as to improve the performance of the electrochemical device and prolong the service life of the electrochemical device.

In an implement solution, measuring a predetermined parameter of the electrochemical device includes measuring a duration of the electrochemical device in the preset state, and in response to the duration being not less than a preset duration, performing at least one discharge-charge operation on the electrochemical device. If the electrochemical device is in the preset state for too long, for example, when the electrochemical device is in a working voltage for too long, it may lead to gas generation and bulging of the electrochemical device and affect the health degree of the electrochemical device. By measuring the duration of the electrochemical device in the preset state and performing the discharge-charge operation on the electrochemical device when the duration is too long, various embodiments of the present application can prevent the electrochemical device from being under high voltage for too long, thereby prolonging the service life of the electrochemical device.

In an implement solution, measuring a predetermined parameter of the electrochemical device includes measuring an internal pressure of the electrochemical device, when the internal pressure of the electrochemical device is measured to be not less than a preset internal pressure of the electrochemical device, performing at least one discharge-charge operation on the electrochemical device. The increase in the internal pressure of the electrochemical device indicates that gas generation may occur in the electrochemical device. By measuring the internal pressure change of the electrochemical device, various embodiments of the present application can timely detect a health problem of the electrochemical device, and inhibit the further gas generation of the electrochemical device by performing the discharge-charge operation on the electrochemical device, so as to improve the performance of the electrochemical device and prolong the service life of the electrochemical device.

In an implement solution, measuring the predetermined parameter of the electrochemical device includes measuring a thickness of the electrochemical device and a duration of the electrochemical device in the preset state, when the thickness is measured to be less than a preset thickness and the duration is measured to be not less than a preset duration, performing at least one discharge-charge operation on the electrochemical device; or when the duration is measured to be less than the preset duration and the thickness is measured to be not less than the preset thickness, performing at least one discharge-charge operation on the electrochemical device; or when the duration is measured to be not less than the preset duration and the thickness is measured to be not less than the preset thickness, performing at least one discharge-charge operation on the electrochemical device. When the duration of the electrochemical device in the preset state is greater than or equal to the preset duration, even if the thickness of the electrochemical device is less than the preset thickness, the discharge-charge operation is also performed, which can prevent gas generation from occurring in the electrochemical device to the greatest extent. When the thickness of the electrochemical device is greater than or equal to the preset thickness, even if the duration of the electrochemical device in the preset state is less than the preset duration, the above discharge-charge operation is also performed, which can also prevent gas generation from occurring in the electrochemical device to the greatest extent. when the duration is measured to be not less than the preset duration and the thickness is measured to be not less than the preset thickness, that is, when the above two parameters meet the preset conditions at the same time, the discharge-charge operation is performed on the electrochemical device. Through the judgment of the parameters in multiple dimensions of the electrochemical device, the timing of the discharge-charge operation can be determined more accurately.

In an implement solution, measuring the predetermined parameter of the electrochemical device includes measuring an internal pressure of the electrochemical device and a duration of the electrochemical device in the preset state, when the internal pressure of the electrochemical device is measured to be less than a preset internal pressure of the electrochemical device and the duration is measured to be not less than a preset duration, performing at least one discharge-charge operation on the electrochemical device; or when the duration is measured to be less than the preset duration and the internal pressure of the electrochemical device is measured to be not less than the preset internal pressure of the electrochemical device, performing at least one discharge-charge operation on the electrochemical device; or when the duration is measured to be not less than the preset duration and the internal pressure of the electrochemical device is measured to be not less than the preset internal pressure of the electrochemical device, performing at least one discharge-charge operation on the electrochemical device. When the duration of the electrochemical device in the preset state is greater than or equal to the preset duration, even if the internal pressure of the electrochemical device is less than the preset internal pressure of the electrochemical device, the discharge-charge operation is also performed, which can prevent gas generation from occurring in the electrochemical device to the greatest extent. When the internal pressure of the electrochemical device is greater than or equal to the preset internal pressure, even if the duration of the electrochemical device in the preset state is less than the preset duration, the discharge-charge operation is also performed, which can also prevent gas generation from occurring in the electrochemical device to the greatest extent. when the duration is measured to be not less than the preset duration and the internal pressure of the electrochemical device is measured to be not less than the preset internal pressure of the electrochemical device, that is, when the above two parameters meet the preset conditions at the same time, the discharge-charge operation is performed on the electrochemical device. Through the judgment of the parameters in multiple dimensions of the electrochemical device, the timing of the discharge-charge operation can be determined more accurately.

In an implement solution, before performing at least one discharge-charge operation on the electrochemical device, the method further comprises: generating prompt information of discharge-charge operation so as to prompt a user that the electrochemical device enters a discharge-charge operation state; after receiving an instruction of performing the discharge-charge operation from the user, starting the discharge-charge operation. Before the discharge-charge operation, by generating the prompt information of discharge-charge operation, the user can know that the electrochemical device will enter the discharge-charge operation state, and the user can decide whether to perform the discharge-charge operation on the current electrochemical device according to the actual situation, so as to improve experience of the user.

In an implement solution, a positive electrode in the electrochemical device includes at least one of Lithium cobalt oxide or Lithium iron phosphate. In an implement solution, when the electrochemical device is an electrochemical device of Lithium cobalt oxide system, that is, when the positive electrode in the electrochemical device includes Lithium cobalt oxide, the first voltage threshold of the electrochemical device is 4.3V to 4.5V. When the electrochemical device is an electrochemical device of Lithium iron phosphate system, that is, when the positive electrode in the electrochemical device includes Lithium iron phosphate, the first voltage threshold of the electrochemical device is 3.5V to 3.7V. When the electrochemical device is a mixed system of Lithium cobalt oxide and Lithium iron phosphate, that is, when the positive electrode in the electrochemical device includes Lithium cobalt oxide and Lithium iron phosphate, the first voltage threshold of the electrochemical device is 4.3V to 4.5V. By setting different first voltage thresholds for electrochemical devices of different systems, the discharge-charge operation on electrochemical devices of different systems can be more targeted, so that the electrochemical devices of different systems can be maintained in a good healthy state, so as to prolong the service life of electrochemical devices under different systems.

A second aspect of some embodiments of the present application provides an electronic device, comprising: a state detection device, a predetermined-parameter measurement device and a discharge-charge device, wherein the state detection device is configured to detect a state of the electrochemical device, the predetermined-parameter measurement device is configured to measure a predetermined parameter of the electrochemical device, and the discharge-charge device is configured to perform at least one discharge-charge operation on the electrochemical device. When the state detection device detects that the electrochemical device is in a preset state, the predetermined-parameter measurement device is notified to measure the predetermined parameter of the electrochemical device. When the predetermined-parameter measurement device measures that the predetermined parameter meets the preset condition, a discharge-charge operation notification is sent. After receiving the discharge-charge operation notification, the discharge-charge device performs the at least one discharge-charge operation. The discharge-charge operation includes: discharging the electrochemical device to a second voltage threshold, and charging the electrochemical device to a third voltage threshold, wherein the second voltage threshold is less than a first voltage threshold, and a difference degree between the third voltage threshold and the first voltage threshold is not greater than 20%. By measuring the predetermined parameter that can reflect a health degree of the electrochemical device with the predetermined-parameter measurement device, some embodiments of the present application performs the discharge-charge operation on the electrochemical device through the discharge-charge device when the predetermined parameter meets the preset condition, so as to reduce the risk of reduction in performance or service life caused by gas generation and bulging of electrochemical device due to long-term high voltage state.

In an implement solution, the preset state includes at least one of the following: a voltage of the electrochemical device is not less than the first voltage threshold, and the electrochemical device is electrically connected with a charging device.

In an implement solution, the predetermined-parameter measurement device includes a thickness measurement device, and/or a duration measurement device, and/or a device for measuring internal pressure of electrochemical device. The thickness measurement device is configured to measure a thickness of the electrochemical device; the duration measurement device is configured to measure a duration of the electrochemical device in a preset state; and the device for measuring internal pressure of electrochemical device is configured to measure an internal pressure of the electrochemical device. The thickness change and internal pressure change of the electrochemical device indicate that gas generation may occur in the electrochemical device, and too long duration of the electrochemical device in a preset state may also lead to gas generation and bulging of the electrochemical device. By measuring the thickness change, and/or the duration in the preset state, and/or internal pressure change of the electrochemical device, some embodiments of the present application inhibit the further gas generation and bulging of the electrochemical device by the discharge-charge operation, so as to improve the performance of the electrochemical device and prolong the service life of the electrochemical device.

In an implement solution, the predetermined parameter meeting the preset condition includes the predetermined parameter is not less than a preset threshold. When the predetermined parameter is not less than the preset threshold, it indicates that the health degree of the electrochemical device decreases, for example, when the predetermined parameter is the thickness of the electrochemical device, the internal pressure of the electrochemical device, or the duration of the electrochemical device is in a preset state, it indicates that the health degree of the electrochemical device decreases. Some embodiments of the present application can perform the discharge-charge operation on the electrochemical device when the health degree of the electrochemical device decreases, so as to reduce the risk of gas generation, bulging, etc. of the electrochemical device.

In an implement solution, the electronic device further comprises: an information prompt device, configured to receive a discharge-charge operation notification and generate prompt information of discharge-charge operation to prompt a user that the electrochemical device enters a discharge-charge operation state. After receiving an instruction of performing the discharge-charge operation from the user, the discharge-charge device performs the at least one discharge-charge operation. Before the discharge-charge operation, by generating the prompt information of discharge-charge operation, the user can know that the electrochemical device will enter the discharge-charge operation state, and the user can decide whether to perform the discharge-charge operation on the current electrochemical device according to the actual situation, so as to improve the user experience.

In an implement solution, a positive electrode in the electrochemical device includes at least one of Lithium cobalt oxide and Lithium iron phosphate. In an implement solution, when the electrochemical device is an electrochemical device of Lithium cobalt oxide system, that is, when the positive electrode in the electrochemical device includes Lithium cobalt oxide, the first voltage threshold of the electrochemical device is 4.3V to 4.5V. When the electrochemical device is an electrochemical device of Lithium iron phosphate system, that is, when the positive electrode in the electrochemical device includes Lithium iron phosphate, the first voltage threshold of the electrochemical device is 3.5V to 3.7V. When the electrochemical device is a mixed system of Lithium cobalt oxide and Lithium iron phosphate, that is, when the positive electrode in the electrochemical device includes Lithium cobalt oxide and Lithium iron phosphate, the first voltage threshold of the electrochemical device is 4.3V to 4.5V. By setting different first voltage thresholds for electrochemical devices of different systems, the discharge-charge operation on electrochemical devices of different systems can be more targeted, so that the electrochemical devices of different systems can be maintained in a good healthy state, so as to prolong the service life of electrochemical devices under different systems.

A third aspect of some embodiments of the present application provides a charging device, comprising a processor and a machine-readable storage medium, wherein the machine-readable storage medium stores machine executable instruction that can be executed by the processor, and when the processor executes the machine executable instruction, a method according to any one of the above-mentioned aspects is realized.

A fourth aspect of some embodiments of the present application provides a computer-readable storage medium, wherein the computer-readable storage medium stores a computer program, and steps of a method according to any one of the above-mentioned aspects are realized when the computer program is executed by a processor.

A fifth aspect of some embodiments of the present application provides a battery system, comprising a processor and a machine-readable storage medium, wherein the machine-readable storage medium stores machine executable instruction that can be executed by the processor, and when the processor executes the machine executable instruction, steps of a method according to any one of above-mentioned aspects are realized.

Some embodiments of the present application provides a management method of an electrochemical device, an electronic device, a charging device and a storage medium, which are mainly used to measure a predetermined parameter of the electrochemical device in a state where the electrochemical device is in a normal use state, a storage state or an intersection state of the normal use and storage states. When the electrochemical device is in a preset state, the predetermined parameter of the electrochemical device is measured. When the predetermined parameter is measured to be not less than the preset threshold, at least one discharge-charge operation is performed on the electrochemical device. The discharge-charge operation is specifically: discharging the electrochemical device to the second voltage threshold, and then charging the electrochemical device to the third voltage threshold, which can significantly delay the gas generation of the electrochemical device, so as to prolong the service life of the electrochemical device. It goes without saying that it is not necessary to achieve all the advantages described above at the same time by implementing any product or method of the present application.

### BRIEF DESCRIPTION OF THE DRAWINGS

In order to more clearly describe the technical solutions of the present application and the prior art, the drawings needed to be used in some embodiments and the prior art are briefly introduced hereinafter. It is obvious that the drawings in the following description are only some embodiments of the present application.

FIG. 1 is a flow diagram of a management method of an electrochemical device according to an embodiment of the present application.

FIG. 2 is a flow diagram of a management method of an electrochemical device according to another embodiment of the present application.

FIG. 3 is a structure diagram of an electronic device according to an embodiment of the present application.

FIG. 4 is a structure diagram of an electronic device according to another embodiment of the present application.

FIG. 5 is a structure diagram of a charging device according to an embodiment of the present application.

FIG. 6 is a structure diagram of a battery system according to an embodiment of the present application.

### DETAILED DESCRIPTION

In order to make the purpose, technical solutions and advantages of the present application more clear, the present application is further described in detail with reference to the accompanying drawings and embodiments hereinafter. Obviously, the described embodiments are only part of some embodiments of the present application, not all of the embodiments. Based on the embodiments in the present application, all other technical solutions obtained by those skilled in the art belong to the claimed scope of the present application.

It should be noted that in the contents of the present application, the present application is described by taking lithium-ion battery as an example of the electrochemical device, but the electrochemical device of the present application is not limited to the lithium-ion battery.

In order to delay the gas generation of the electrochemical device and prolong the service life of the electrochemical device, some embodiments of the present application provide a management method of an electrochemical device, an electronic device, a charging device, a storage medium and a battery system.

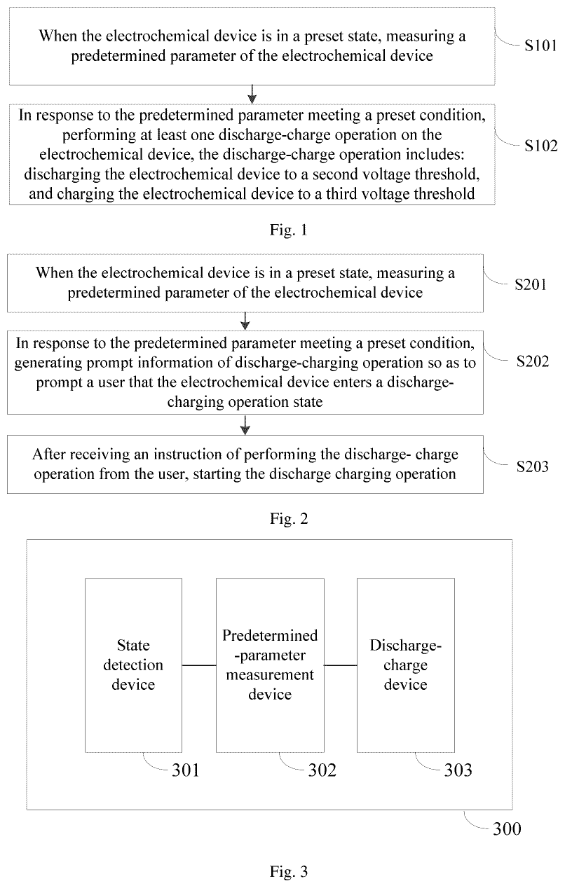

An embodiment of the present application provides a management method of an electrochemical device. As shown in FIG. 1, the method includes the following steps:

S101: when the electrochemical device is in a preset state, measuring a predetermined parameter of the electrochemical device.

A state detection device detects a state of the electrochemical device. When the electrochemical device is in a preset state, a predetermined-parameter measurement device measures the predetermined parameter of the electrochemical device. For example, referring to FIG. 3, when the state detection device 301 detects that the electrochemical device is in a preset state, the state detection device 301 sends a signal to the predetermined-parameter measurement device 302. After receiving the signal, the predetermined-parameter measurement device 302 measures the predetermined parameter of the electrochemical device. The operation of the process shown above is only for the purpose of description. In addition, the device modules in the example of electronic equipment cited in the embodiment of the present application are only for the purpose of description and not restrictive.

Electrochemical devices usually have different states, for example, the electrochemical device is in a charge state, a discharge state, a static state, etc. The above different states usually correspond to different conditions of the electrochemical device, such as working condition, storage condition, or working/storage intersection condition. Wherein, the working condition can refer to a condition that the electrochemical device is in the state of discharge, charge, or charge-discharge, and the storage condition can refer to a condition that the electrochemical device is placed without being in the state of discharge, charge, or charge-discharge.

In some embodiments of the present application, when the electrochemical device is in the preset state, the predetermined-parameter measurement device can timely determine a health degree of the electrochemical device by measuring the predetermined parameter. The predetermined parameter of some embodiments of the present application can be a parameter related to the health degree of the electrochemical device, and the health degree of the electrochemical device can be used to reflect a deterioration of the electrochemical device due to a non-external force damage factor, such as gas generation of the electrochemical device, etc. Specifically, the above predetermined parameter may include, but are not limited to, at least one of a thickness of the electrochemical device, an internal pressure of the electrochemical device, and a duration of the electrochemical device in a preset state.

Embodiment of the present application have no special restrictions on the device used to measure the above parameters, as long as the purpose of the present application can be realized. For example, a built-in clock is used to measure the duration of the electrochemical device in a predetermined state, a size measurement device is used to measure the thickness of the electrochemical device, a pressure sensor is used to measure the internal pressure of the electrochemical device, etc. For example, the size measurement device may be a distance sensor arranged between the surface of the electrochemical device and a housing containing the electrochemical device, and the sensor can obtain the gas generation of the electrochemical device by measuring the distance between the surface of the electrochemical device and the housing. For example, the smaller the measured distance, the more serious the gas generation.

The electrochemical device of some embodiments of the present application may include at least one lithium-ion battery. When a plurality of lithium-ion batteries is included, these lithium-ion batteries may exist in the electrochemical device in series and/or in parallel.

S102: in response to the predetermined parameter meeting a preset condition, performing at least one discharge-charge operation on the electrochemical device. The discharge-charge operation includes: discharging the electrochemical device to a second voltage threshold, and charging the electrochemical device to a third voltage threshold, wherein the second voltage threshold is less than a first voltage threshold, and a difference degree between the third voltage threshold and the first voltage threshold is not greater than 20%.

For example, after the predetermined-parameter measurement device 302 measures the predetermined parameter of the electrochemical device, the predetermined-parameter measurement device 302 sends a signal to the discharge-charge device 303 in response to the predetermined parameter meeting the preset condition. After receiving the signal, the discharge-charge device 303 discharges the electrochemical device to the second voltage threshold, and then charges the electrochemical device to the third voltage threshold. The operation of the above process is only for the purpose of description. In addition, the devices and modules in the example of electronic equipment cited in the embodiment of the present application are only for the purpose of description and not restrictive.

The first voltage threshold of the present application may refer to a limited charge voltage of the electrochemical device. The limited charge voltage refers to a voltage value when the lithium-ion battery is transferred from constant current charge to constant voltage charge according to the regulations of the manufacturer. Generally speaking, the voltage of lithium-ion battery will rise continuously during constant current charge, when it rises to the “limited charge voltage”, the battery will no longer be charged, which will continue to increase its voltage, but will enter the constant voltage charge stage so as to prevent damaging and irreversible electrochemical reaction in the battery.

The second voltage threshold of the present application may refer to a discharge cut-off voltage of the electrochemical device. The discharge cut-off voltage refers to a minimum voltage allowed when the lithium-ion battery is discharged. Generally speaking, if the battery continues to be discharged when its voltage exceeds the minimum discharge voltage of lithium-ion battery, the internal pressure of the battery will rise, and the reversibility of positive and negative active material will be damaged, thereby the battery life will be shortened. Therefore, when the electrochemical device is discharged to the cut-off voltage, it will no longer be discharged, so as to prevent the positive and negative active material from being damaged.

In some embodiments of the present application, after the predetermined-parameter measurement device measures the predetermined parameter of the electrochemical device, in response to the predetermined parameter meeting the preset condition, the discharge-charge device may perform at least one discharge-charge operation on the electrochemical device, which is: discharging the electrochemical device to the second voltage threshold, and then charging the electrochemical device to the third voltage threshold, wherein the second voltage threshold is less than the first voltage threshold, and the difference degree between the third voltage threshold and the first voltage threshold is not greater than 20%. For example, the third voltage threshold is equal to the first voltage threshold. In the present application, the difference degree between two objects is the ratio of the absolute value of the difference between the two objects to the smaller of the two objects. Through the above at least one discharge-charge operation, the risk of reduction in performance or service life caused by gas generation and bulging of the electrochemical device due to long-term high voltage can be reduced. After the discharge-charge operation, the electrochemical device can still maintain sufficient power for easy use at any time, thereby improving the convenience of the electrochemical device. The above discharge-charge operation can be realized by a discharge-charge circuit in the discharge-charge device.

The preset condition of embodiments of the present application can be preset by those in the art according to needs, for example, the voltage, thickness, or duration of the electrochemical device in the preset state is in a certain condition, etc. The embodiment of the present application has no special limit on the times of the above at least once discharge-charge operation, as long as the purpose of the present application can be realized. From the perspective of effectively prolonging the service life of the electrochemical device, the times of the above discharge-charge operation are at least once, such as once, twice, three times, etc. From the perspective of user convenience, it is usually no more than 10 times, and further, it is usually no more than 4 times. The embodiment of the present application has no special restrictions on the specific values of the first voltage threshold, the second voltage threshold and the third voltage threshold, as long as the above relationship is satisfied, and it is usually determined according to the specific type of electrochemical device.

In one embodiment, the predetermined parameter meeting the preset condition includes: the predetermined parameter is greater than or equal to the preset threshold. For example, the predetermined parameter may include the thickness of the electrochemical device, the duration of the electrochemical device in a preset state or the internal pressure of the electrochemical device, we may set the thickness of the electrochemical device to reach a certain threshold, or the duration of the electrochemical device in the preset state to reach a certain threshold, or the internal pressure of the electrochemical device to reach a certain threshold, etc. When the predetermined parameter is greater than or equal to the preset threshold, at least one discharge-charge operation can be performed on the electrochemical device.

In an implement solution, the preset state includes at least one of the following: a working voltage of the electrochemical device is not less than the first voltage threshold, and the electrochemical device is electrically connected with a charging device.

In the embodiment of the present application, the working voltage may refer to a voltage of the electrochemical device in the discharge state, a voltage in the state of charge-discharge, or an open circuit voltage of the electrochemical device in the storage state. The first voltage threshold can be determined by technical staff according to actual needs. For example, when a voltage of the electrochemical device is higher than a certain voltage, there may be risks such as gas generation and bulging, and the voltage can be determined as the first voltage threshold. The electrical connection between the electrochemical device and the charging device may refer to that the electrochemical device is electrically connected with the charging device by wired or wireless means. It goes without saying that the electrochemical device may be in a state where the working voltage is not less than the first voltage threshold and the electrochemical device is electrically connected with the charge device at the same time. In various embodiments of the present application, when at least one of the working voltage of the electrochemical device being not less than the first voltage threshold and the electrochemical device and the charge being electrically connected happens is satisfied, the predetermined parameter of the electrochemical device can be measured timely to reduce the risk of reduction in performance or service life caused by gas generation or bulging due to the voltage of the electrochemical device higher than the first voltage threshold for a long term or the electrochemical device electrical connected with the charge device for a long term, so as to prolong the service life of the electrochemical device.

In one embodiment, when the electrochemical device is in a preset state, the thickness of the electrochemical device is measured.

The thickness change of electrochemical device can reflect the health degree of electrochemical device. For example, when the thickness of the electrochemical device increases, it indicates that gas generation may occur inside the electrochemical device and deterioration starts. Based on this, when the electrochemical device is in the preset state, the thickness of the electrochemical device can be measured to determine the thickness change of the electrochemical device. When the thickness is measured to be not less than the preset thickness, at least one discharge-charge operation is performed on the electrochemical device.

The preset thickness can be a thickness preset by the technical staff according to the actual needs, which is not specifically limited in various embodiments of the present application, as long as the purpose of various embodiments of the present application can be realized. Electrochemical devices of different systems or with different structures and sizes can also correspond to different preset thicknesses. For example, an electrochemical device of Lithium cobalt oxide system and an electrochemical device of Lithium iron phosphate system can correspond to different preset thicknesses, and an electrochemical device with a winding structure and an electrochemical device with a laminated structure can correspond to different preset thicknesses. Various embodiments of the present application have no special restrictions on the device for measuring the thickness of the electrochemical device, as long as the purpose of the present application can be realized, for example, the existing thickness measurement device can be used. Various embodiments of the present application can timely measure the thickness change of the electrochemical device, and reduce the risk of reduction in performance or service life caused by gas generation and bulging of the electrochemical device through the above discharge-charge operation.

In one embodiment, when the electrochemical device is in a preset state, the duration of the electrochemical device in the preset state is measured.

The duration of electrochemical device in a preset state can reflect the health degree of electrochemical device. For example, when the duration of the electrochemical device in the preset state is too long, such as too long duration under high voltage, the electrochemical device may occur gas generation and bulging. Based on this, when the electrochemical device is in a preset state, the duration of the electrochemical device in the preset state can be measured, so as to determine the duration of the electrochemical device in the preset state.

When the duration is measured to be not less than the preset duration, at least one discharge-charge operation is performed on the electrochemical device.

The preset duration can be a duration preset by the technical staff according to the actual needs, which is not specifically limited in various embodiments of the present application, as long as the purpose of various embodiments of the present application can be realized. Electrochemical devices of different systems or with different structures and sizes can also correspond to different preset durations. For example, an electrochemical device of Lithium cobalt oxide system and an electrochemical device of Lithium iron phosphate system can correspond to different preset durations, and an electrochemical device with a winding structure and an electrochemical device with a laminated structure can correspond to different preset durations. As an example, the preset duration can be 6 hours, 8 hours, 10 hours, 15 hours, 20 hours, etc. Various embodiments of the present application have no special restrictions on the device for measuring the duration of the electrochemical device, as long as the purpose of the present application can be realized, for example, the existing timing device can be used. Various embodiments of the present application can timely measure the duration of the electrochemical device in a preset state, and further reduce the risk of reduction in performance or service life caused by gas generation and bulging of the electrochemical device through the above discharge-charge operation, so as to prolong the service life of electrochemical devices.

In one embodiment, when the electrochemical device is in a preset state, the internal pressure of the electrochemical device is measured.

The internal pressure change of electrochemical device can reflect the health degree of electrochemical device. For example, when the internal pressure of the electrochemical device increases, it indicates that gas generation and bulging may occur inside the electrochemical device. Based on this, when the electrochemical device is in the preset state, the internal pressure of the electrochemical device can be measured, so as to determine the internal pressure change of the electrochemical device.

When the internal pressure of the electrochemical device is measured to be not less than a preset internal pressure of the electrochemical device, at least one discharge-charge operation is performed on the electrochemical device.

The preset internal pressure of the electrochemical device can be an internal pressure preset by the technical staff according to the actual needs, which is not specifically limited in various embodiments of the present application, as long as the purpose of various embodiments of the present application can be realized. Electrochemical devices of different systems or with different structures and sizes can also correspond to different preset internal pressures. For example, an electrochemical device of Lithium cobalt oxide system and an electrochemical device of Lithium iron phosphate system can correspond to different preset internal pressures, and an electrochemical device with a winding structure and an electrochemical device with a laminated structure can correspond to different preset internal pressures. Various embodiments of the present application have no special restrictions on the device for measuring the internal pressure of the electrochemical device, as long as the purpose of the present application can be realized, for example, the existing internal-pressure measurement device of the electrochemical device can be used. Various embodiments of the present application can timely measure the internal pressure change of the electrochemical device, and further reduce the risk of reduction in performance or service life caused by gas generation and bulging of the electrochemical device through the above discharge-charge operation, so as to prolong the service life of electrochemical devices.

In a preferred embodiment, when the electrochemical device is in a preset state, the thickness of the electrochemical device and the duration of the electrochemical device in the preset state are measured.

The thickness of the electrochemical device and the duration in the preset state can both be related to the health degree of the electrochemical device. Based on this, when the electrochemical device is in the preset state, the thickness of the electrochemical device and the duration of the electrochemical device in the preset state can be measured together, so as to determine the thickness change of the electrochemical device and the duration of the electrochemical device in the preset state.
when the thickness is measured to be less than the preset thickness and the duration is measured to be not less than the preset duration, at least one discharge-charge operation is performed on the electrochemical device.
when the duration of the electrochemical device in the preset state is greater than or equal to the preset duration, even if the thickness of the electrochemical device is less than the preset thickness, the above discharge-charge operation is also performed, so as to reduce the risk of reduction in performance or service life caused by gas generation and bulging of the electrochemical device and prolong the service life of the electrochemical device.

Or, when the duration is measured to be less than the preset duration and the thickness is measured to be not less than the preset thickness, at least one discharge-charge operation is performed on the electrochemical device.
when the thickness is greater than or equal to the preset thickness, even if the duration of the electrochemical device in the preset state is less than the preset duration, the above discharge-charge operation is also performed, so as to reduce the risk of reduction in performance or service life caused by further gas generation and bulging of the electrochemical device and prolong the service life of the electrochemical device.

Or, when the duration is measured to be not less than the preset duration and the thickness is not less than the preset thickness, at least one discharge-charge operation is performed on the electrochemical device.
when the above two parameters meet the preset conditions at the same time, the discharge-charge operation is performed on the electrochemical device. Through the judgment of the parameters of the electrochemical device in multiple dimensions, the timing of the discharge-charge operation can be determined more accurately, so as to reduce the risk of reduction in performance or service life caused by further gas generation and bulging of the electrochemical device, and prolong the service life of the electrochemical device. At the same time, when the gas generation of the electrochemical device is not serious, it is not necessary to frequently perform the discharge-charge operation, so as to improve the user experience of using the electrochemical device.

In another preferred implement solution, when the electrochemical device is in a preset state, the internal pressure of the electrochemical device and the duration of the electrochemical device in the preset state are measured.

The internal pressure of the electrochemical device and the duration in the preset state can both be related to the health degree of the electrochemical device. Based on this, in various embodiments of the present application, when the electrochemical device is in the preset state, the internal pressure of the electrochemical device and the duration of the electrochemical device in the preset state can be measured together, so as to determine the internal pressure change of the electrochemical device and the duration of the electrochemical device in the preset state.
when the internal pressure of the electrochemical device is measured to be less than the preset internal pressure of the electrochemical device and the duration is measured to be not less than the preset duration, at least one discharge-charge operation is performed on the electrochemical device.
when the duration of the electrochemical device in the preset state is greater than or equal to the preset duration, even if the internal pressure of the electrochemical device is less than the preset internal pressure of the electrochemical device, the discharge-charge operation is also performed, so as to reduce the risk of reduction in performance or service life caused by further gas generation and bulging of the electrochemical device and prolong the service life of the electrochemical device.

Or, when the duration is measured to be less than the preset duration and the internal pressure of the electrochemical device is not less than the preset internal pressure of the electrochemical device, at least one discharge-charge operation is performed on the electrochemical device.
when the internal pressure of the electrochemical device is greater than or equal to the preset internal pressure, even if the duration of the electrochemical device in the preset state is less than the preset duration, the discharge-charge operation is also performed, so as to reduce the risk of reduction in performance or service life caused by further gas generation and bulging of the electrochemical device.

Or, when the duration is measured to be not less than the preset duration and the internal pressure of the electrochemical device is measured to be not less than the preset internal pressure of the electrochemical device, at least one discharge-charge operation is performed on the electrochemical device.

When the above two parameters meet the preset conditions at the same time, the discharge-charge operation is performed on the electrochemical device. Through the judgment of the parameters of the electrochemical device in multiple dimensions, the timing of the discharge-charge operation can be determined more accurately, so as to further reduce the risk of reduction in performance or service life caused by gas generation and bulging of the electrochemical device. At the same time, when the gas generation of the electrochemical device is not serious, it is not necessary to frequently perform the discharge-charge operation, so as to improve the user experience of using the electrochemical device.

An embodiment of the present application further provides a management method of an electrochemical device, as shown in FIG. 2, including the following steps:

S201: when the electrochemical device is in a preset state, measuring a predetermined parameter of the electrochemical device.

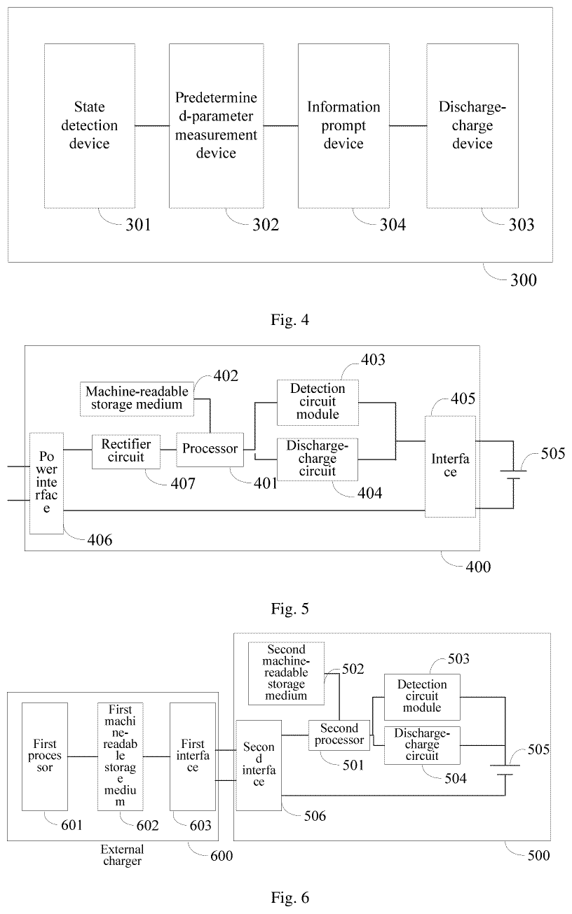

Referring to FIG. 4, the state detection device 301 detects the state of the electrochemical device. when the electrochemical device is in the preset state, the predetermined-parameter measurement device 302 measures the predetermined parameter.

For example, when the state detection device 301 in the electronic device detects that the electrochemical device is in a preset state, the state detection device 301 sends a signal to the predetermined-parameter measurement device 302. After receiving the signal, the predetermined-parameter measurement device 302 measures the predetermined parameter of the electrochemical device.

This step is the same as step S101 of the method embodiment shown in FIG. 1, and will not be repeated herein.

S202: in response to the predetermined parameter meeting a preset condition, generating prompt information of discharge-charge operation so as to prompt a user that the electrochemical device will enter a discharge-charge operation state.

For example, after the predetermined-parameter measurement device 302 measures the predetermined parameter of the electrochemical device, the predetermined-parameter measurement device 302 sends a signal to an information prompt device 304 in response to the predetermined parameter meeting the preset condition. After receiving the signal, the information prompt device 304 generates prompt information of discharge-charge operation to prompt the user that the electrochemical device will enter the discharge-charge operation state.

The prompt information of discharge-charge operation can include but is not limited to at least one method of text prompt, voice prompt, light prompt, vibration prompt and other prompt, so as to prompt the user whether the electrochemical device enters the discharge-charge operation state.

S203, after receiving an instruction of performing the discharge-charge operation from the user, starting the discharge-charge operation.

For example, after receiving an instruction of performing the discharge-charge operation from a user, the information prompt device 304 sends a signal to the discharge-charge device 303, and the discharge-charge device 303 receives the signal to start the discharge-charge operation. The operation of the above process is only for the purpose of description, and the devices and modules in the example of electronic device cited in various embodiments of the present application are only for the purpose of description and not restrictive.

The discharge-charge device can start the discharge-charge operation after receiving the instruction of performing the discharge-charge operation from the user, so as to facilitate deciding whether to perform the discharge-charge operation on the current electrochemical device for the user, which improves experience of the user. Various embodiments of the present application have no special restrictions on the form of instructions sent by the user, such as clicking a button of confirming to perform the discharge-charge operation, sending a voice instruction of confirming to perform the discharge-charge operation, etc.

In the electrochemical device of some embodiments of the present application, a positive electrode can includes at least one of Lithium cobalt oxide and Lithium iron phosphate. Generally speaking, electrochemical devices of different systems correspond to different first voltage thresholds.

In an implement solution, when the electrochemical device is an electrochemical device of Lithium cobalt oxide system, that is, when the positive electrode in the electrochemical device includes Lithium cobalt oxide, the first voltage threshold of the electrochemical device is 4.3V to 4.5V.

In an implement solution, when the electrochemical device is an electrochemical device of Lithium iron phosphate system, that is, when the positive electrode in the electrochemical device includes Lithium iron phosphate, the first voltage threshold of the electrochemical device is 3.5V to 3.7V.

In an implement solution, when the electrochemical device is a mixed system of Lithium cobalt oxide and Lithium iron phosphate, that is, when the positive electrode in the electrochemical device includes Lithium cobalt oxide and Lithium iron phosphate, the first voltage threshold of the electrochemical device is 4.3V to 4.5V.

According to some embodiments of the present application, by setting different first voltage thresholds for electrochemical devices of different systems, the discharge-charge operation on electrochemical devices of different systems can be more targeted, so that the electrochemical devices of different systems can be maintained in a good healthy state, so as to prolong the service life of electrochemical devices of different systems.

An embodiment of the present application further provides an electronic device 300. As shown in FIG. 3, the electronic device 300 includes a state detection device 301, a predetermined-parameter measurement device 302 and a discharge-charge device 303. Wherein,
the state detection device 301 is configured to detect a state of the electrochemical device, the predetermined-parameter measurement device 302 is configured to measure a predetermined parameter of the electrochemical device, and the discharge-charge device 303 is configured to perform at least one discharge-charge operation on the electrochemical device. When the state detection device 301 detects that the electrochemical device is in a preset state, the predetermined-parameter measurement device 302 is notified to measure the predetermined parameter of the electrochemical device. When the predetermined-parameter measurement device 302 measures that the predetermined parameter meets the preset condition, a discharge-charge operation notification is sent. After receiving the discharge-charge operation notification, the discharge-charge device 303 performs the at least one discharge-charge operation. The discharge-charge operation includes: discharging the electrochemical device to a second voltage threshold, and charging the electrochemical device to a third voltage threshold, wherein the second voltage threshold is less than a first voltage threshold, and a difference degree between the third voltage threshold and the first voltage threshold is not greater than 20%.

The electronic device of the embodiment of the present application may include an electrochemical device. For example, the electronic equipment may be a device such as mobile phone and tablet computer with built-in lithium ion battery and data processing capability. The present application have no special restrictions on the state detection device 301, the predetermined-parameter measurement device 302 and the discharge-charge device 303, as long as the corresponding functions can be realized.

In an implement solution, the preset state includes at least one of the following: a voltage of the electrochemical device is not less than the first voltage threshold, and the electrochemical device is electrically connected with a charging device.

In an implement solution, the predetermined-parameter measurement device includes a thickness measurement device, and/or a duration measurement device, and/or a device for measuring internal pressure of electrochemical device. Wherein, the thickness measurement device is configured to measure a thickness of the electrochemical device; the duration measurement device is configured to measure a duration of the electrochemical device in a preset state. The device for measuring internal pressure of electrochemical device is configured to measure an internal pressure of the electrochemical device.

In an implement solution, the predetermined parameter meeting the preset condition includes the predetermined parameter is not less than a preset threshold.

In an implement solution, as shown in FIG. 4, the electronic device of the embodiment of the present application further includes: an information prompt device 304, configured to receive a discharge-charge operation notification and generate the prompt information of discharge-charge operation to prompt a user that the electrochemical device will enter a discharge-charge operation state. After receiving an instruction of performing the discharge-charge operation from the user, the discharge-charge device 303 performs the at least one discharge-charge operation.

In an implement solution, a positive electrode in the electrochemical device includes at least one of Lithium cobalt oxide and Lithium iron phosphate.

In an implement solution, when the electrochemical device is an electrochemical device of Lithium cobalt oxide system, that is, when the positive electrode in the electrochemical device includes Lithium cobalt oxide, the first voltage threshold of the electrochemical device is 4.3V to 4.5V; when the electrochemical device is an electrochemical device of Lithium iron phosphate system, that is, when the positive electrode in the electrochemical device includes Lithium iron phosphate, the first voltage threshold of the electrochemical device is 3.5V to 3.7V; when the electrochemical device is a mixed system of Lithium cobalt oxide and Lithium iron phosphate, that is, when the positive electrode in the electrochemical device includes Lithium cobalt oxide and Lithium iron phosphate, the first voltage threshold of the electrochemical device is 4.3V to 4.5V.

An embodiment of the present application provides an electronic device, which is mainly used for an electrochemical device in a normal use state, a storage state or a state where normal use and storage intersect. Wherein, the state detection device is configured to detect a state of the electrochemical device, the predetermined-parameter measurement device is configured to measure a predetermined parameter of the electrochemical device, and the discharge-charge device is configured to perform at least one discharge-charge operation on the electrochemical device, which can significantly delay the gas generation of the electrochemical device, so as to prolong the service life of the electrochemical device.

An embodiment of the present application further provides a charging device. As shown in FIG. 5, this charging device 400 includes a processor 401 and a machine-readable storage medium 402, and the charging device 400 may further includes a detection circuit module 403, a discharge-charge circuit 404, an interface 405, a power interface 406, and a rectifier circuit 407. Wherein, the detection circuit module 403 is configured to detect a state and/or parameter of a lithium-ion battery 505, such as detecting a voltage of the lithium-ion battery, and send a detection result to the processor 401, the discharge-charge circuit 404 is configured to receive an instruction from the processor 401 to preform the discharge-charge operation on the lithium-ion battery 505, the interface 405 is configured to electrically connect with the lithium-ion battery 505, the power interface 406 is configured to connect with an external power supply, the rectifier circuit 407 is configured to rectify an input current, and the machine-readable storage medium 402 stores a machine-executable instruction that can be executed by the processor. When the processor 401 executes the machine-executable instruction, steps of the method described in any of the above embodiments are realized, which can significantly delay the gas generation of the electrochemical device, so as to prolong the service life of the electrochemical device.

An embodiment of the present application further provides a computer-readable storage medium. The computer-readable storage medium stores a computer program, and steps of the method described in any of the above embodiments are realized when the computer program is executed by the processor, which can significantly delay the gas generation of the electrochemical device, so as to prolong the service life of the electrochemical device.

An embodiment of the present application further provides a battery system. As shown FIG. 6, the battery system 500 includes a second processor 501 and a second machine-readable storage medium 502, and the battery system 500 may further include a detection circuit module 503, a discharge-charge circuit 504, a lithium-ion battery 505 and a second interface 506. Wherein, the detection circuit module 503 is configured to detect a state and/or parameter of the lithium-ion battery 505, such as detecting a voltage of the lithium-ion battery and sending a detection result to the second processor 501, the discharge-charge circuit 504 is configured to receive an instruction from the second processor 501 to perform a discharge-charge operation on the lithium-ion battery 505, the second interface 506 is configured to electrically connect with an interface of an external charger 600, the external charger 600 is configured to supply power, and the second machine-readable storage medium 502 stores machine executable instruction that can be executed by the processor. When the second processor 501 executes the machine executable instruction, steps of the method described in any of the above embodiments are realized, which can significantly delay the gas generation of the electrochemical device, so as to prolong the service life of the electrochemical device. The external charger 600 may include a first processor 601, a first machine-readable storage medium 602, a first interface 603 and a corresponding rectifier circuit. The external charger may be a commercial charger, and the embodiment of the present application does not specifically limit its structure.

The machine-readable storage medium may include a random access memory (simply referred to as RAM) or non-volatile memory, such as at least one disk memory. Alternatively, the memory may also be at least one storage device located away from the processor.

The above-mentioned processor can be a general-purpose processor, including Central Processing Unit (simply referred to as CPU) and Network Processor (simply referred to as NP), and so on. The above-mentioned processor can also be Digital Signal Processing (simply referred to as DSP), Application Specific Integrated Circuit (simply referred to as ASIC), Field-Programmable Gate Array (simply referred to as FPGA) or other programmable logic devices, discrete gate or transistor logic devices, and discrete hardware components.

For some embodiments of electronic equipment/charging device/storage medium/battery system, since it is basically similar to the method embodiment, the description is relatively simple. For relevant parts, please refer to the partial description of the method embodiment.

### Preparation Example 1

Preparation of Electrochemical Device of Lithium Cobalt Oxide System:

Preparation of positive electrode: mixing positive active materials Lithium cobalt oxide, acetylene black and polyvinylidene fluoride (PVDF) according to a mass ratio of 94:3:3, and then adding N-Methylpyrrolidone (NMP) as solvent to prepare a slurry with a solid content of 75% and stirring evenly. The slurry is evenly coated on one surface of aluminum foil with a thickness of 12 μm, dried at 90° C. and is subject to cold pressing, so as to obtain a positive electrode with a positive active material layer with a thickness of 100 μm, and then the above steps are repeated on the other surface of the positive electrode to obtain a positive electrode coated with positive active material layers on both surfaces. The positive electrode is cut in a specification of 74 mm×867 mm and welded with a tab for use.

Preparation of negative electrode: mixing negative active materials artificial graphite, acetylene black, Styrene-Butadiene rubber and sodium carboxymethyl cellulose according to a mass ratio of 96:1:1.5:1.5, and then adding deionized water as solvent to prepare a slurry with a solid content of 70% and stirring evenly. The slurry is evenly coated on one surface of copper foil with a thickness of 8 μm, dried at 110° C. and is subject to cold pressing, so as to obtain a negative electrode coated with a negative active material layer with a thickness of 150 μm on one surface, and then the above coating steps are repeated on the other surface of the negative electrode to obtain a negative electrode coated with negative active material layers on both surfaces. The negative electrode is cut in a specification of 74 mm×867 mm and welded with a tab for use.

Preparation of separator: using polyethylene (PE) porous polymeric film with a thickness of 15 μm as a separator.

Preparation of electrolyte: in an environment with water content less than 10 ppm, mixing non-aqueous organic solvents ethylene carbonate (EC), propylene carbonate (PC) and diethyl carbonate (DEC) according to a mass ratio of 1:1:1, and then adding Lithium hexafluorophosphate (LiPF₆) to the non-aqueous organic solvent to dissolve and mix evenly, so as to obtain the electrolyte, wherein the concentration of LiPF₆ is 1.15 mol/l.

Preparation of electrochemical device: stacking the positive electrode, separator and negative electrode prepared above in order, making the separator be located between the positive electrode and negative electrode to play the role of separation, and winding to obtain the electrode assembly; then putting the electrode assembly into an aluminum-plastic film packaging bag, removing the water at 80° C., injecting the prepared electrolyte, and obtaining the electrochemical device through vacuum packaging, standing, formation, shaping and other processes.

### Preparation Example 2

Preparation of Electrochemical Device of Lithium Iron Phosphate System:

Preparation of positive electrode: mixing positive active materials Lithium iron phosphate, acetylene black and polyvinylidene fluoride (PVDF) according to a mass ratio of 94:3:3, and then adding N-Methylpyrrolidone (NMP) as solvent to prepare a slurry with a solid content of 75% and stirring evenly. The slurry is evenly coated on one surface of aluminum foil with a thickness of 12 μm, dried at 90° C. and is subject to cold pressing, so as to obtain a positive electrode with a positive active material layer with a thickness of 100 μm, and then the above steps are repeated on the other surface of the positive electrode to obtain a positive electrode coated with positive active material layers on both surfaces. The positive electrode is cut in a specification of 74 mm×867 mm and welded with a tab for use.

The preparation methods of negative electrode, separator, electrolyte and electrochemical device are the same as those in Preparation Example 1.

### Preparation Example 3

Preparation of Electrochemical Device of a Mixed System of Lithium Cobalt Oxide and Lithium Iron Phosphate:

Preparation of positive electrode: mixing positive active material Lithium cobalt oxide and Lithium iron phosphate, acetylene black and polyvinylidene fluoride (PVDF) according to the mass ratio of 94:3:3 (wherein the mass ratio of Lithium cobalt oxide to Lithium iron phosphate is 1:1), and then adding N-Methylpyrrolidone (NMP) as solvent to prepare a slurry with solid content of 75% and stirring evenly. The slurry is evenly coated on one surface of aluminum foil with a thickness of 12 μm, dried at 90° C. and is subject to cold pressing, so as to obtain a positive electrode with a positive active material layer with a thickness of 100 μm, and then the above steps are repeated on the other surface of the positive electrode to obtain a positive electrode coated with positive active material layers on both surfaces. The positive electrode is cut in a specification of 74 mm×867 mm and welded with a tab for use.

The preparation methods of negative electrode, separator, electrolyte and electrochemical device are the same as those in Preparation Example 1.

### Example 1

Test of Electrochemical Device of Lithium Cobalt Oxide System:

Taking the electrochemical device prepared in Preparation Example 1, firstly charging the electrochemical device to 4.4V at a constant current with a charge current of 5 A, then charging the electrochemical device to 250 mA at a constant voltage, standing for 6 days, measuring a thickness of the electrochemical device with a thickness measurement equipment (PPG soft pack battery thickness gauge, Manufacturer: Yinghaoda, Model: PPG1000), and recording it as a thickness before test.

Discharge-charge operation: discharging the electrochemical device to a voltage of 3V at a constant current with a discharge current of 5 A, then charging the electrochemical device to a voltage of 4.4V at a constant current with a charge current of 5 A and standing for 2 days. The discharge-charge operation is repeated until the electrochemical device generates gas, the thickness of the electrochemical device is measured and recorded as a thickness after test.

### Example 2

Test of Electrochemical Device of Lithium Iron Phosphate System:

Taking the electrochemical device prepared in Preparation Example 2, firstly charging the electrochemical device to 3.6V at a constant current with a charge current of 5 A, then charging the electrochemical device to 250 mA at a constant voltage, standing for 6 days, measuring a thickness of the electrochemical device, and recording it as a thickness before test.

Discharge-charge operation: discharging the electrochemical device to a voltage of 2.5V at a constant current with a discharge current of 5 A, then charging the electrochemical device to a voltage of 3.6V at a constant current with a charge current of 5 A and standing for 2 days. The discharge-charge operation is repeated until the electrochemical device generates gas, the thickness of the electrochemical device is measured and recorded as a thickness after test.

### Example 3

Test of Electrochemical Device of a Mixed System of Lithium Cobalt Oxide and Lithium Iron Phosphate:

Taking the electrochemical device prepared in Preparation Example 3, firstly charging the electrochemical device to 4.4V at a constant current with a charge current of 5 A, then charging the electrochemical device to 250 mA at a constant voltage, standing for 6 days, measuring a thickness of the electrochemical device, and recording it as a thickness before test.

Discharge-charge operation: discharging the electrochemical device to a voltage of 3V at a constant current with a discharge current of 5 A, then charging the electrochemical device to a voltage of 4.4V at a constant current with a charge current of 5 A and standing for 2 days. The discharge-charge operation is repeated until the electrochemical device generates gas, the thickness of the electrochemical device is measured and recorded as a thickness after test.

### Example 4

Taking the electrochemical device prepared in Preparation Example 1, firstly charging the electrochemical device to 4.4V at a constant current with a charge current of 5 A, then charging the electrochemical device to 250 mA at a constant voltage, standing for 6 days, measuring a thickness of the electrochemical device with a thickness measurement equipment (PPG soft pack battery thickness gauge, Manufacturer: Yinghaoda, Model: PPG1000), and recording it as a thickness before test.

Discharge-charge operation: discharging the electrochemical device to a voltage of 3V at a constant current with a discharge current of 5 A, then charging the electrochemical device to a voltage of 4.4V at a constant current with a charge current of 5 A, repeating the discharge-charge operation for total twice, and standing for 2 days, the above is recorded as one discharge-charge operation process. The discharge-charge operation is repeated until the electrochemical device generates gas, the thickness of the electrochemical device is measured and recorded as a thickness after test.

### Example 5

Except that the discharge-charge operation process is repeated for total 3 times, the rest is the same as Embodiment 4.

### Example 6

Except that the discharge-charge operation process is repeated for total 4 times, the rest is the same as Embodiment 4.

### Example 7

Except that the discharge-charge operation process is repeated for total 5 times, the rest is the same as Embodiment 4.

### Comparative Example 1

Taking the electrochemical device of Lithium cobalt oxide system prepared in Preparation Example 1, firstly charging the electrochemical device to 4.4V at a constant current with a charge current of 5 A, then charging the electrochemical device to 250 mA at a constant voltage, standing for 6 days, measuring a thickness of the electrochemical device, and recording it as a thickness before test.

Then charging the electrochemical device to a voltage of 4.4V at a constant current with a charge current of 5 A, and standing for 2 days. The discharge-charge operation is repeated until the electrochemical device generates gas, the thickness of the electrochemical device is measured and recorded as a thickness after test.

### Comparative Example 2

Taking the electrochemical device of Lithium iron phosphate system prepared in Preparation Example 2, firstly charging the electrochemical device to 3.6V at a constant current with a charge current of 5 A, then charging the electrochemical device to 250 mA at a constant voltage, standing for 6 days, measuring a thickness of the electrochemical device, and recording it as a thickness before test.

Then charging the electrochemical device to a voltage of 3.6V at a constant current with a charge current of 5 A, and standing for 2 days. The discharge-charge operation is repeated until the electrochemical device generates gas, the thickness of the electrochemical device is measured and recorded as a thickness after test.

### Comparative Example 3

Taking the electrochemical device of a mixed system of Lithium cobalt oxide and Lithium iron phosphate prepared in Preparation Example 3, firstly charging the electrochemical device to 4.4V at a constant current with a charge current of 5 A, then charging the electrochemical device to 250 mA at a constant voltage, standing for 6 days, measuring a thickness of the electrochemical device, and recording it as a thickness before test.

Then charging the electrochemical device to a voltage of 4.4V at a constant current with a charge current of 5 A, and standing for 2 days. The discharge-charge operation is repeated until the electrochemical device generates gas, the thickness of the electrochemical device is measured and recorded as a thickness after test.

An expansion rate of the electrochemical device of each embodiment and comparative example is calculated by the following expression:

Expansion rate=(thickness of electrochemical device after test−thickness of electrochemical device before test)/thickness of electrochemical device before test×100%.

The performance data of Examples 1 to 7 and Comparative Examples 1 to 3 are shown in Table 1:

TABLE 1

| | | Thickness | Thickness | |
|---|---|---|---|---|
| | Days of gas | before | after | Expansion |
| Group | generation | test (mm) | test (mm) | rate |
| Example 1 | 597 | 8.245 | 9.399 | 14% |
| Example 2 | 858 | 10.412 | 11.766 | 13% |
| Example 3 | 612 | 12.542 | 14.423 | 15% |
| Example 4 | 654 | 8.354 | 9.357 | 12% |
| Example 5 | 720 | 8.265 | 9.339 | 13% |
| Example 6 | 794 | 8.122 | 9.097 | 12% |
| Example 7 | 852 | 8.322 | 9.237 | 11% |
| Comparative | 378 | 8.235 | 9.553 | 16% |
| Example1 | | | | |
| Comparative | 649 | 10.345 | 11.474 | 11% |
| Example2 | | | | |
| Comparative | 487 | 12.312 | 14.036 | 14% |
| Example3 | | | | |

It can be seen from Example 1 and Comparative Example 1, Example 2 and Comparative Example 2, Example 3 and Comparative Example 3 that after using the discharge-charge operation of the present application, the days of gas generation of the electrochemical device are significantly prolonged, and at a case where the cycle days are all significantly prolonged, the expansion rates of various electrochemical devices are very close, which indicates that management method of the electrochemical device of the present application can significantly delay the gas generation of the electrochemical device and prolong the service life of the electrochemical device.

It can be seen from Examples 1 to 3 that for electrochemical devices of different systems, after using the discharge-charge operation of the present application, the days of gas generation are significantly prolonged, which indicates that the management method of the electrochemical device of the present application can significantly delay the gas generation of electrochemical devices, so as to prolong the service life of electrochemical devices of different systems.

It can be seen from Examples 4 to 7 that the times of discharge-charge operations will also affect the days of gas generation and expansion rate of the electrochemical device, but as long as the times of discharge-charge operations is within the scope of the present application, the gas generation of the electrochemical device can be significantly delayed and the service life of the electrochemical device can be prolonged.

It should be noted that in this description, relational terms such as first and second are only used to distinguish one entity or operation from another entity or operation, and do not necessarily require or imply any such actual relationship or order between these entities or operations. Moreover, the terms “include”, “comprise” or any other variation thereof are intended to cover non-exclusive inclusion, so that a process, method, article or equipment including a series of elements includes not only those elements, but also other elements not explicitly listed, or elements inherent in such process, method, article or equipment. Without further restrictions, the elements defined by the statement “including a . . . ” do not exclude the existence of other same elements in the process, method, article or equipment including the elements.

Each embodiment in this description is described in a relevant way. The same and similar parts of each embodiment can be referred to each other. Each embodiment focuses on the differences from other embodiments. In particular, for the electronic device embodiment, since it is basically similar to the method embodiment, the description is relatively simple. For relevant parts, please refer to the partial description of the method embodiment.

The above is only a preferred embodiment of the present application and is not used to limit the claimed scope of the present application. Any modification, equivalent replacement, improvement, etc. made within the spirit and principles of the present application are included in the claimed scope of the present application.

What is claimed is:

1. A management method of an electrochemical device, wherein the method comprises:
in a preset state of the electrochemical device, measuring a predetermined parameter of the electrochemical device; and
in response to the predetermined parameter meeting a preset condition, performing at least one discharge-charge operation on the electrochemical device, wherein the discharge-charge operation includes:
discharging the electrochemical device to a second voltage threshold, wherein the second voltage threshold is less than a first voltage threshold, and the first voltage threshold is a limited charge voltage of the electrochemical device; and
charging the electrochemical device to a third voltage threshold, wherein a difference between the third voltage threshold and the first voltage threshold is not greater than 20%.

2. The management method of the electrochemical device according to claim 1, wherein the step of in response to the predetermined parameter meeting the preset condition, performing at least one discharge-charge operation on the electrochemical device includes:
in response to the predetermined parameter being not less than a preset threshold, performing at least one discharge-charge operation on the electrochemical device.

3. The management method of the electrochemical device according to claim 1, wherein the preset state includes at least one of the following: a working voltage of the electrochemical device is not less than the first voltage threshold, or the electrochemical device is electrically connected with a charging device.

4. The management method of the electrochemical device according to claim 1, wherein the step of measuring a predetermined parameter of the electrochemical device includes measuring a thickness of the electrochemical device, and the step of in response to the predetermined parameter meeting the preset condition, performing at least one discharge-charge operation on the electrochemical device includes:
in response to the thickness being not less than a preset thickness, performing at least one discharge-charge operation on the electrochemical device.

5. The management method of the electrochemical device according to claim 1, wherein the step of measuring a predetermined parameter of the electrochemical device includes measuring a duration of the electrochemical device in the preset state, and the step of in response to the predetermined parameter meeting the preset condition, performing at least one discharge-charge operation on the electrochemical device includes:
in response to the duration being not less than a preset duration, performing at least one discharge-charge operation on the electrochemical device.

6. The management method of the electrochemical device according to claim 1, wherein the step of measuring a predetermined parameter of the electrochemical device includes measuring an internal pressure of the electrochemical device, and the step of in response to the predetermined parameter meeting the preset condition, performing at least one discharge-charge operation on the electrochemical device includes:
when the internal pressure of the electrochemical device is measured to be not less than a preset internal pressure of the electrochemical device, performing at least one discharge-charge operation on the electrochemical device.

7. The management method of the electrochemical device according to claim 1, wherein the step of measuring a predetermined parameter of the electrochemical device includes measuring a thickness of the electrochemical device and a duration of the electrochemical device in the preset state, and the step of in response to the predetermined parameter meeting the preset condition, performing at least one discharge-charge operation on the electrochemical device includes at least one of the following steps:
when the thickness is measured to be less than a preset thickness and the duration is measured to be not less than a preset duration, performing at least one discharge-charge operation on the electrochemical device;
when the duration is measured to be less than the preset duration and the thickness is measured to be not less than the preset thickness, performing at least one discharge-charge operation on the electrochemical device; or
when the duration is measured to be not less than the preset duration and the thickness is measured to be not less than the preset thickness, performing at least one discharge-charge operation on the electrochemical device.

8. The management method of the electrochemical device according to claim 1, wherein the step of measuring a predetermined parameter of the electrochemical device includes measuring an internal pressure of the electrochemical device and a duration of the electrochemical device in the preset state, and the step of in response to the predetermined parameter meeting the preset condition, performing at least one discharge-charge operation on the electrochemical device includes at least one of the following steps:
when the internal pressure of the electrochemical device is measured to be less than a preset internal pressure of the electrochemical device and the duration is measured to be not less than a preset duration, performing at least one discharge-charge operation on the electrochemical device;
when the duration is measured to be less than the preset duration and the internal pressure of the electrochemical device is measured to be not less than the preset internal pressure of the electrochemical device, performing at least one discharge-charge operation on the electrochemical device; and
when the duration is measured to be not less than the preset duration and the internal pressure of the electrochemical device is measured to be not less than the preset internal pressure of the electrochemical device, performing at least one discharge-charge operation on the electrochemical device.

9. The management method of the electrochemical device according to claim 1, wherein before performing at least one discharge-charge operation on the electrochemical device, the method further comprises:
generating prompt information of a discharge-charge operation so as to prompt a user that the electrochemical device enters a discharge-charge operation state; and
after receiving an instruction of performing the discharge-charge operation from the user, starting the discharge-charge operation.

10. The management method of the electrochemical device according to claim 1, wherein a positive electrode in the electrochemical device includes at least one of Lithium cobalt oxide or Lithium iron phosphate.

11. The management method of the electrochemical device according to claim 10, wherein when the electrochemical device is an electrochemical device of Lithium cobalt oxide system, the first voltage threshold of the electrochemical device is 4.3V to 4.5V;
when the electrochemical device is an electrochemical device of Lithium iron phosphate system, the first voltage threshold of the electrochemical device is 3.5V to 3.7V;
when the electrochemical device is a mixed system of Lithium cobalt oxide and Lithium iron phosphate, the first voltage threshold of the electrochemical device is 4.3V to 4.5V.

12. A charging device, comprising a processor and a machine-readable storage medium, wherein the machine-readable storage medium stores machine executable instruction and the processor is configured to execute the machine executable instruction to realize the management method of the electrochemical device as claimed in claim 1.

13. An electronic device, wherein the electronic device comprises: a state detection device, a predetermined-parameter measurement device and a discharge-charge device;
the state detection device is configured to detect a state of the electrochemical device;
the predetermined-parameter measurement device is configured to measure a predetermined parameter of the electrochemical device;
the discharge-charge device is configured to perform at least one discharge-charge operation on the electrochemical device;
when the state detection device detects that the electrochemical device is in a preset state, the predetermined-parameter measurement device is notified to measure the predetermined parameter of the electrochemical device;
in response to the predetermined-parameter measurement device measuring that the predetermined parameter meet the preset condition, a discharge-charge operation notification is sent;
after receiving the discharge-charge operation notification, the discharge-charge device performs the at least one discharge-charge operation;
the discharge-charge operation includes:
discharging the electrochemical device to a second voltage threshold, wherein the second voltage threshold is less than a first voltage threshold, and the first voltage threshold is a limited charge voltage of the electrochemical device; and
charging the electrochemical device to a third voltage threshold, wherein a difference degree between the third voltage threshold and the first voltage threshold is not greater than 20%.

14. The electronic device according to claim 13, wherein the preset state includes at least one of the following: a voltage of the electrochemical device is not less than the first voltage threshold, or the electrochemical device is electrically connected with a charging device.

15. The electronic device according to claim 13, wherein the predetermined-parameter measurement device includes a thickness measurement device, and/or a duration measurement device, and/or a device for measuring internal pressure of electrochemical device;
the thickness measurement device is configured to measure a thickness of the electrochemical device;
the duration measurement device is configured to measure a duration of the electrochemical device in the preset state;
the device for measuring internal pressure of electrochemical device is configured to measure an internal pressure of the electrochemical device.

16. The electronic device according to claim 13, wherein the predetermined parameter meeting the preset condition includes the predetermined parameter is not less than a preset threshold.

17. The electronic device according to claim 14, wherein the electronic device further comprises:
an information prompt device, configured to receive a discharge-charge operation notification and generate prompt information of discharge-charge operation to prompt a user that the electrochemical device enters a discharge-charge operation state; wherein
after receiving an instruction of performing the discharge-charge operation from the user, the discharge-charge device performs the at least one discharge-charge operation.

18. The electronic device according to claim 13, wherein a positive electrode in the electrochemical device includes at least one of Lithium cobalt oxide or Lithium iron phosphate.

19. The electronic device according to claim 13, wherein when the electrochemical device is an electrochemical device of Lithium cobalt oxide system, the first voltage threshold of the electrochemical device is 4.3V to 4.5V;
when the electrochemical device is an electrochemical device of Lithium iron phosphate system, the first voltage threshold of the electrochemical device is 3.5V to 3.7V;
when the electrochemical device is a mixed system of Lithium cobalt oxide and Lithium iron phosphate, the first voltage threshold of the electrochemical device is 4.3V to 4.5V.
